(19) United States
(12) Patent Application Publication
(10) Pub. No.: US 2009/0037294 A1
(43) Pub. Date: Feb. 5, 2009

(54) MOBILE COMMUNICATION DEVICE TRANSACTION CONTROL SYSTEMS

(75) Inventor: Anil Malhotra, Cambridge Cambridgeshire (GB)

Correspondence Address: SCHWEGMAN, LUNDBERG & WOESSNER, P.A., P.O. BOX 2938, MINNEAPOLIS, MN, 55402, US

(73) Assignee: Bango.net Limited, Cambridgeshire (GB)

(21) Appl. No.: 12/177,479

(22) Filed: Jul. 22, 2008

Related U.S. Application Data
(60) Provisional application No. 60/952,337, filed on Jul. 27, 2007.

(51) Int. Cl. G06Q 30/00

(52) U.S. Cl. 705/27; 705/1

(57) ABSTRACT

A method of enabling a user of a mobile device to select a billing method for a transaction to acquire an item of content, the method comprising: implementing steps on a meta-payment server, comprising: logging content provider data and content item metadata for a plurality of items of content, said content item metadata comprising a link; logging phone network data comprising a user identification number; storing a list of available payment methods, each with allowed types of content for which a payment using the payment method may be made and a maximum transaction value; generating/identifying an account for said user comprising, a transaction history for said user defining previous successful and unsuccessful payments made by said user and the payment method for each; receiving a request from a content provider comprising a request for said meta-payment server to serve a list of payment methods to said user in response to said content provider; receiving a request from said user to purchase a said item of content by activation of said link; reading said content item metadata for said identified item of content; reading a recent portion of said transaction history data for said user; identifying a plurality of available payment methods for said user to pay for said item of content by filtering said available payment methods using said portion of said transaction history and said content item metadata for said item of content in association with said payment method data; and sending from said meta-payment server to said user, as a mobile web page, said identified selection of a plurality of available payment methods as a set of links each of said links activating a respective said payment method, together with a price of said item of content such that by selecting a said link the user is able to pay by the selected method.

### RELATED APPLICATION

This application claims priority under 35 U.S.C. 119(e) from U.S. Provisional Patent Application Ser. No. 60/952,337, filed Jul. 27, 2007, which application is incorporated herein by reference.

### FIELD OF THE INVENTION

The present invention relates to mobile communication device transaction control systems, in particular to method and apparatus for computer systems to enable a user of a mobile device such as a mobile phone to select a billing method for a transaction to acquire an item of content.

### BACKGROUND TO THE INVENTION

Many different types of content are available for mobile devices, in particular mobile telephones and the variety of these has increased with the increasing sophistication and complexity of the mobile devices themselves. However, the task of serving content to mobile devices is complicated by a number of factors, including the large number of mobile devices available on the market today having widely differing capabilities, differences in the underlying network infrastructure provided by different mobile network operators, and the various different means of paying for items of content available on different mobile networks. A content provider wishing to serve content to a user of a mobile device must contend with all of these factors in order to serve the widest possible number of users. This greatly increases the barrier to entry for mobile content providers, as each one has to deal with ever increasing number and complexity of the above problems as the number of mobile devices, content types and, network operators and billing methods increase, and this represents a significant challenge for new content providers wishing to enter the market.

Accordingly, it would be advantageous to provide a system and methods for overcoming the above-described problems.

### SUMMARY OF THE INVENTION

According to an aspect of the present invention, there is provided a method of enabling a user of a mobile device to select a billing method for a transaction to acquire an item of content, the method comprising: implementing steps on a meta-payment server, said meta-payment server communicating with a plurality of billing servers for a plurality of payment providers, a plurality of content providers and one or more phone networks each having a plurality of said users, the steps comprising: logging content provider data from one or more of said content providers, said content provider data comprising a content provider identification, and content item metadata for a plurality of items of content, said content item metadata comprising a resource location address for a link to be displayed by said content provider on a content provider mobile web site for access by a said user to obtain a said item of content, price data associated with said item of content, and a content item identifier identifying said item of content; logging phone network data from said phone network, said phone network data comprising at least a user identification number of said user; storing in a data store a list of available payment methods, each having payment method data defining allowed types of content for which a payment using the payment method may be made and a maximum transaction value; generating an account or identifying an existing account for said user using said user identification number, said account comprising, in an account data store, a transaction history for said user, wherein said transaction history comprises data defining previous successful and unsuccessful payments made by said user and said payment method for each said payment; receiving a content provider request from a content provider or from a content provider via a user, said content provider request comprising a request for said meta-payment server to serve a list of payment methods to said user in response to said content provider receiving a request from said user to purchase a said item of content by activation of said link, said item of content being identified by a said content item (“Bango Number”) identifier provided with said content provider request; reading said content item metadata for said identified item of content; reading a recent portion of said transaction history data for said user from said account data store; identifying a selection comprising a plurality of said available payment methods for said user to pay for said item of content by filtering said available payment methods using said portion of said transaction history and said content item metadata for said item of content in association with said payment method data; and sending from said meta-payment server to said user via said phone network of said user, as a mobile web page, said identified selection of a plurality of available payment methods as a set of links each of said links activating a respective said payment method, together with a price of said item of content such that by selecting a said link the user is able to pay by the selected method.

In this document it will be understood by the person skilled in the art that the item of content can also comprise a service, for example a time-limited subscription.

The link activating payment methods may comprise links to the meta-payment server, where the meta-payment server sends billing data to a billing server appropriate to that payment method, such billing data comprising user identification data (for example the user's telephone number) and the price of the item of content.

The payment methods may be ranked according to a number of different metrics, or according to a weighted sum of one or more metrics, for example a probability of payment completion and an estimate of the time taken to payment completion. This may be done using data for the users previous transaction history and/or previous transaction history for all users, users on the same mobile network or users of the same content provider.

In the above-described method, it may not be necessary for the user to register with the meta-payment server before the meta-payment server can select a payment method.

The payment methods may have a requirement for a minimum transaction value and this may be higher than the cost of an individual item of content. In this situation, the user may purchase an item of content and be billed for the payment methods minimum transaction value, and the system maintains a record of the difference between the item of content price and the amount charged by the payment method, in order to credit this amount against the users future purchases using this system.

Certain payment methods may not allow particular types of content to be purchased, for example age-related content, and this may be provided for by filtering the list of payment methods to remove any such payment methods which do not allow a particular item of content.

The items of content maybe identified using a content item identifier, and this may be embedded as part of the uniform resource locater (URL). The item of content may be addressed at several different locations, according to data formats suitable for supplying the item of content to devices having different capabilities or using different file formats.

In another aspect the invention provides a method of determining a preferred transaction method for a transaction between a user and a content provider, the transaction involving an item of content, the method comprising: for each of one or more possible transaction methods, determining whether a transaction method is permissible between the said user and the said content provider for the said item of content; and selecting a preferred transaction method and a next preferred transaction method from one or more permissible transaction methods according to rules.

Preferably each of the one or more permissible transaction methods has an associated speed of transaction, and selecting a preferred transaction method comprising selecting a method with the fastest speed. Further each of the permissible transaction methods may have an associated transaction error rate, in which case the selecting may further comprise selecting a method with the lowest error rate.

In a related aspect there is therefore also provided a method of optimising speed of transaction for a transaction between a user and a content provider, the method comprising: for each of one or more possible transaction methods, determining whether a transaction method is permitted between the said user and the said content provider for the said item of content; and selecting a fastest transaction method from one or more permitted transaction methods.

There is further provided a method of minimising transaction error rate for a transaction between a user and a content provider, the method comprising: for each of one or more possible transaction methods, determining whether a transaction method is permitted between the said user and the said content provider for the said item of content; and selecting a transaction method having a lowest transaction error rate from one or more permitted transaction methods.

The invention further provides processor control code to implement the above-described methods, for example on a general purpose computer system or on a digital signal processor (DSP). The code may be provided on a carrier such as a disk, CD- or DVD-ROM, programmed memory such as read-only memory (Firmware), or on a data carrier such as an optical or electrical signal carrier. Code (and/or data) to implement embodiments of the invention may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog (Trade Mark) or VHDL (Very high speed integrated circuit Hardware Description Language). As the skilled person will appreciate such code and/or data may be distributed between a plurality of coupled components in communication with one another.

In a further related aspect there is provided an apparatus for enabling a user of a mobile device to select a billing method for a transaction to acquire an item of content, the apparatus comprising a meta-payment server configured to communicate with a plurality of billing servers for a plurality of payment providers, a plurality of content providers and one or more phone networks each having a plurality of said used, the meta-payment sever comprising: means for logging content provider data from one or more of said content providers, said content provider data comprising a content provider identification, and content item meta data for a plurality of items of content, said content item meta data comprising a resource location address for a link to be displayed by said content provider on a content provider mobile web site for access by a said user to obtain a said item of content, price data associated with said item of content, and a content item identifier identifying said item of content; means for logging phone network data from said phone network, said phone network data comprising at least a user identification number of said user; means for storing in a data store a list of available payment methods, each having payment method data defining allowed types of content for which a payment using the payment method may be made and a maximum transaction value; means for generating an account or identifying an existing account for said user using said user identification number, said account comprising, in an account data store, a transaction history for said user, wherein said transaction history comprises data defining previous successful and unsuccessful payments made by said user and said payment method for each said payment; means for receiving a content provider request from a content provider or from a content provider via a user, said content provider request comprising a request for said meta-payment server to serve a list of payment methods to said user in response to said content provider receiving a request from said user to purchase a said item of content by activation of said link, said item of content being identified by a said content item (“Bango Number”) identifier provided with said content provider request; means for reading said content item metadata for said identified item of content; means for reading a recent portion of said transaction history data for said user from said account data store; means for identifying a selection comprising a plurality of said available payment methods for said user to pay for said item of content by filtering said available payment methods for said user to pay for said item of content by filtering said available payment methods using said portion of said transaction history and said content item meta data for said item of content in association with said payment method data; and means for sending from said meta-payment server to said user via said phone network of said user, as a mobile web page, said identified selection of a plurality of available payment methods as a set of links each of said links activating a respective said payment method, together with a price of said item of content such that by selecting a said link the user is able to pay by the selected method.

Preferably each link of said set of links activating a respective said payment method comprises a link to said meta-payment server, and the method/apparatus further comprises (means for) sending from said meta-payment server to a said billing server identified by said selected payment method, billing data comprising said user identification number of said user and an amount to bill said user.

Preferably said identified selection of a plurality of available payment methods sent to said user is ranked according to one or both of a likelihood of a successful payment being completed and an estimated speed of completion of said payment for said user, responsive to said transaction history data for a plurality of said users.

In preferred embodiments there is no need for registration of a user with the meta-payment server.

In embodiments at least one of said payment methods has a requirement for a minimum transaction value, and said payment method data includes data defining a said minimum transaction value for said payment method. Then the method/apparatus preferably further comprises (means for) identifying selection of a said payment method with a minimum transaction value by a said user and storing a difference between said price of said item of content and said minimum transaction value of said price is less than said minimum transaction value, and offsetting a price of a subsequent purchase of an item of content by said stored difference.

Preferably said payment method data includes payment option combination data defining when one of said payment methods is not permitted to be offered to a user in a selection with a second of said payment methods. The method/apparatus may then further comprise (means for) restricting said selection of available payment methods using said payment option combination data.

In embodiments the link resource location address includes the content item identifier as part of the resource location address. The apparatus/method may then further comprise (means for) storing a plurality of content item addresses for a single said content item identifier, each for presenting said content using a different data format on a said mobile device. The method/apparatus may then further comprise detecting in real time a said data format of said mobile device used by said user and aborting said transaction for said user to acquire said item of content if said detected data format of said mobile device does not correspond to a data format in which said item of content is available.

In a further aspect the invention provides an apparatus for determining a preferred transaction method for a transaction between a user and a content provider, the transaction involving an item of content, the apparatus comprising: a data memory storing one or more possible transaction methods; and a processor coupled to said data memory and to program memory storing processor control code for controlling the processor, when running, to: for each of said one or more possible transaction methods, determine whether a transaction method is permissible between the said user and the said content provider for the said item of content; and select a preferred transaction method from one or more permitted transaction methods according to rules.

### BRIEF DESCRIPTION OF DRAWINGS

These and other aspects of the invention will now be further described, by way of example only, with reference to the accompanying figures in which:

FIG. 1 shows a “BillRank” system architecture according to an embodiment of an aspect of the invention; and

FIG. 2 shows a flow diagram of a procedure to implement a billing method according to an embodiment of the invention.

### DETAILED DESCRIPTION OF PREFERRED EMBODIMENTS

Broadly speaking we will describe a procedure which aims to dynamically deliver the maximum probability of transaction success by increasing the consumer's ease of payment, in conjunction with the best earnings rates for a content provider.

Embodiments of the system we describe employ knowledge and rules as input and intelligently output the correct primary and secondary payment options for any specific transaction. Embodiments employ a comprehensive and extensible set of data and rules, which may either be intimation specific to the current transaction or stored from previous transactions or rules set by the system or third parties such as operators or billing providers.

Preferred embodiments include the following data items:

Consumer (This is the user initiating the transaction).
User ID
Operator
Country
Handset
Language
Transaction history
Tracking information
Account status
Consumer rating
Credit/debit card details
PayPal account details (linked)
Payment preference

Content provider (This is the content provider that owns the content).
Customer ID
Content price
Content currency preferences
Content rating
Minimum acceptable earnings rate
Preferences
Customer rating
Content info (price, rating, currency).

In some preferred embodiments the system analyses a plurality of billing channels for selection as the primary and secondary methods presented to the consumer. Preferred embodiments use the following parameters:
Current availability—is the serve live or does it have faults?
Countries and operators covered
Content types approved (U, R, G)
Earnings rate
Payment process—the number of steps involved or complexity to complete the transaction.
Ant-fraud information

Preferred embodiments also employ the following additional data:

Operator (This is the operator that the consumer uses
Access policy
Transaction regulations
Approved payment methods
Content types approved (U, R, G)

Finance (Financial information concerning exchange rates between the consumer's country of origin and the content provider's currency preferences. This is used for automatic currency conversion).
Currency exchange rates
Tax rules

Country (This is the country where the content is being purchased, reflecting the laws and regulations that may apply).
Laws and policies
Content types approved (U, R, G)
Tax rules

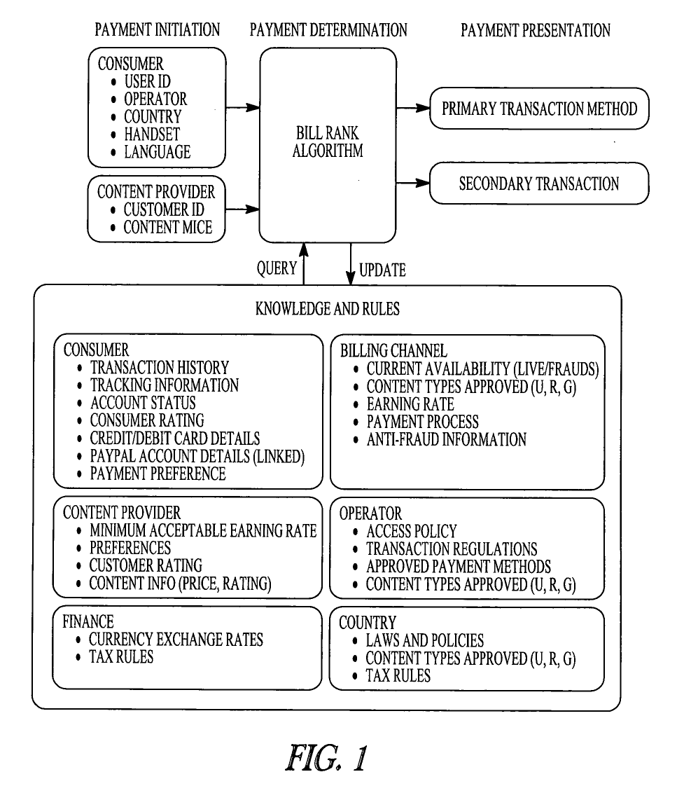

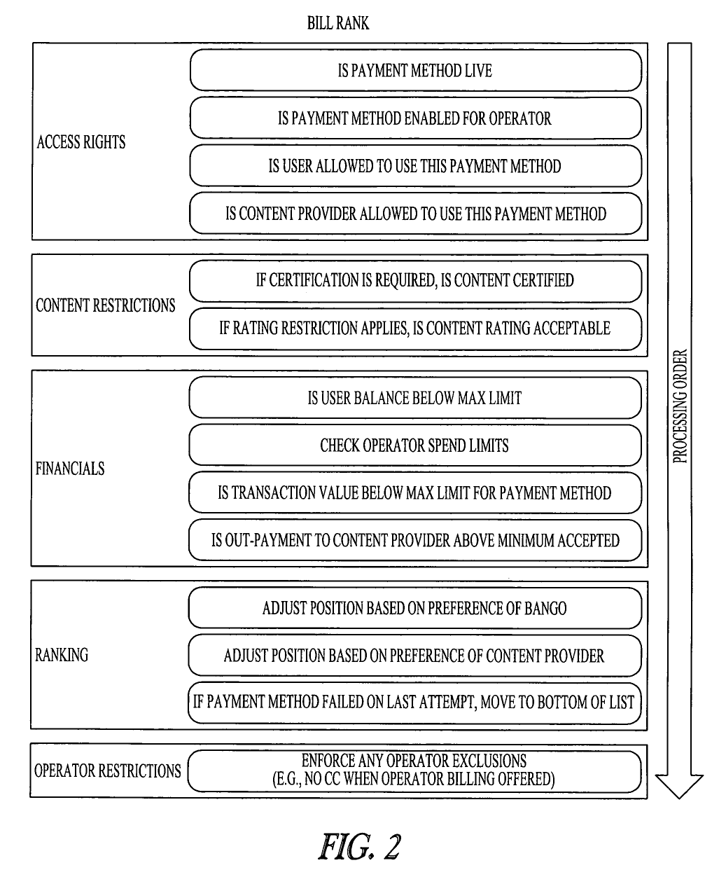

Referring to FIG. 1, this shows an architecture of a computer system to implement an embodiment of the invention. This comprises, broadly speaking, payment initiation, involving the consumer and content provider, payment determination, involving the “BillRank” procedure as described above and illustrated in FIG. 2, and payment presentation, involving primary and secondary transaction methods. As described above the BillRank procedure operates in conjunction with a set of knowledge and rules.

The BillRank procedure is shown in the flow diagram of FIG. 2, and applies the rules and knowledge described above and shown in FIG. 1 to deliver outputs based upon a range of factors/parameters, as illustrated in FIG. 2.

Transaction success optimisation: The procedure selects payments methods that delivery the highest success (conversion rate). When multiple billing options are available, it will select the one delivering the highest chance of a transaction completing. BillRank:
Minimises the number of steps—this will prefer a 1-click on bill payment option where available for example.
Applies consumer preference—identification of the user, along with payment history and preferences across multiple transactions and sites.

Payment failure prevention: The procedure detects when a consumer repeatedly fails to pay using their chosen method and suggests alternatives. Because it sees all the transactions a consumer makes across multiple sites it can quickly minimise risk of payment failure allowing even new content stores to benefit immediately.

Fraud prevention: The system monitors consumer transactions across all mobile content powered by the system, e.g. world wide. This allows the system to identify fraudulent transaction patterns and remove those payment options from the consumer's choice. Even as a new customer, a content provider immediately benefits from years of consumer purchasing knowledge by using the technology.

Operator rule compliance: Operators regularly change their policies to meet business needs. Because embodiments use these policies to drive its algorithms; changes in operator policy can be automatically and immediately applied across all content providers. This gives immediate global compliance without the need to individually track and adapt as operators and other billing providers make changes to their service.

Secure transaction approval with payment guarantees: When the system accepts a payment transaction and passes the consumer back to the content provider's site for download it is effectively delivering a secure transaction approval. This intelligence eliminates problems encountered with old-style mobile payment solutions where money is “clawed back” when transactions fail (sometimes called charge-backs). The logic can substantially eliminate potential payment failures ahead of time, allowing Bango to guarantee payment for everyone we pass back as successful.

Payout maximization: The logic prefers payment methods with the highest earnings rate. This means that billing providers offering low rates may see less payment traffic than those with high rates. Say Company X offers the highest rate, so where consumers have bound their Company X and Bango (system operator) accounts, company is presented wherever possible in order to deliver the highest possible payout rate. Note that PayPal is not used for R rated content or where operator rules forbid.

Automatic billing channel failover: The logic can automatically provide an alternative method of payment should the preferred operator or third party billing method be unavailable. Whilst this is rare, when it does happen it can be commercially catastrophic if BillRank™ technology is not used.

Automatic personalization: The logic remembers the consumer's preferred payment method between transactions, making it quick and easy to purchase further items. The customer preference is automatically set when they select a secondary payment method (credit card or Company X for example). These preferences apply across all mobile content powered by the system, making it consistent and easy to buy.

Country and operator optimization: The logic uses country and operator information associated with the consumer to help select the correct payment method. This is usually a 1-click on-bill payment method using direct billing integration or Premium SMS billing depending on the best earnings rate and country availability.

Differentiation: The system is different from traditional payment solutions which unintelligently select a single option based on content provider preference alone, often manually implemented. These systems use no knowledge of the consumer preferences or purchasing trends across the content provider sites they visit. They do not apply rules based on operator policies or local laws or attempt to identify fraud or payment issues. Embodiments of the system we describe employs a unique technical algorithm to achieve this and to scale and keep abreast of changes in data or policies.

No doubt many other effective alternatives will occur to the skilled person. It will be understood that the invention is not limited to the described embodiments and encompasses modifications apparent to those skilled in the art lying within the spirit and scope of the claims appended hereto.

1. A method of enabling a user of a mobile device to select a billing method for a transaction to acquire an item of content, the method comprising:
implementing steps on a meta-payment server, said meta-payment server communicating with a plurality of billing servers for a plurality of payment providers, a plurality of content providers and one or more phone networks each having a plurality of said users, the steps comprising:
logging content provider data from one or more of said content providers, said content provider data comprising a content provider identification, and content item metadata for a plurality of items of content, said content item metadata comprising a resource location address for a link to be displayed by said content provider on a content provider mobile web site for access by a said user to obtain a said item of content, price data associated with said item of content, and a content item identifier identifying said item of content;
logging phone network data from said phone network, said phone network data comprising at least a user identification number of said user;
storing in a data store a list of available payment methods, each having payment method data defining allowed types of content for which a payment using the payment method may be made and a maximum transaction value;
generating an account or identifying an existing account for said user using said user identification number, said account comprising, in an account data store, a transaction history for said user, wherein said transaction history comprises data defining previous successful and unsuccessful payments made by said user and said payment method for each said payment;
receiving a content provider request from a content provider or from a content provider via a user, said content provider request comprising a request for said meta-payment server to serve a list of payment methods to said user in response to said content provider receiving a request from said user to purchase a said item of content by activation of said link, said item of content being identified by a said content item identifier provided with said content provider request;
reading said content item metadata for said identified item of content;
reading a recent portion of said transaction history data for said user from said account data store;
identifying a selection comprising a plurality of said available payment methods for said user to pay for said item of content by filtering said available payment methods using said portion of said transaction history and said content item metadata for said item of content in association with said payment method data; and
sending from said meta-payment server to said user via said phone network of said user, as a mobile web page, said identified selection of a plurality of available payment methods as a set of links each of said links activating a respective said payment method, together with a price of said item of content such that by selecting a said link the user is able to pay by the selected method.

2. A method as claimed in claim 1 wherein each link of said set of links activating a respective said payment method comprises a link to said meta-payment server, the method further comprising sending from said meta-payment server to a said billing server identified by said selected payment method, billing data comprising said user identification number of said user and an amount to bill said user.

3. A method as claimed in claim 1 wherein said identified selection of a plurality of available payment methods sent to said user is ranked according to one or both of a likelihood of a successful payment being completed and an estimated speed of completion of said payment for said user, responsive to said transaction history data for a plurality of said users.

4. A method as claimed in claim 1 wherein said method is performed without registration of a said user with said meta-payment server.

5. A method as claimed in claim 1 wherein at least one of said payment methods has a requirement for a minimum transaction value, wherein said payment method data includes data defining a said minimum transaction value for said payment method, and wherein said method further comprises identifying selection of a said payment method with a minimum transaction value by a said user and storing a difference between said price of said item of content and said minimum transaction value of said price is less than said minimum transaction value, and offsetting a price of a subsequent purchase of an item of content by said stored difference.

6. A method as claimed in claim 1 wherein said payment method data includes payment option combination data defining when one of said payment methods is not permitted to be offered to a user in a selection with a second of said payment methods, the method further comprising restricting said selection of available payment methods using said payment option combination data.

7. A method as claimed in claim 1 wherein said link resource location address includes said content item identifier as part of said resource location address.

8. A method as claimed in claim 6 further comprising storing a plurality of content item addresses for a single said content item identifier, each for presenting said content using a different data format on a said mobile device and wherein the method further comprises detecting in real time a said data format of said mobile device used by said user and aborting said transaction for said user to acquire said item of content if said detected data format of said mobile device does not correspond to a data format in which said item of content is available.

9. A carrier carrying computer program code to implement the method of claim 1.

10. A meta-payment server including the carrier of claim 9.

11. A method of determining a preferred transaction method for a transaction between a user and a content provider, the transaction involving an item of content, the method comprising:
for each of one or more possible transaction methods, determining whether a transaction method is permissible between the said user and the said content provider for the said item of content; and
selecting a preferred transaction method and a next preferred transaction method from one or more permissible transaction methods according to rules.

12. A method according to claim 11, wherein each of said one or more permissible transaction methods has an associated speed of transaction and wherein selecting a preferred transaction method comprises selecting a transaction method having a fastest speed of transaction.

13. A method according to claim 11, wherein each of said one or more permissible transaction methods has an associated transaction error rate and wherein selecting a preferred transaction method comprises selecting a transaction method having a lowest transaction error rate.

14. A method of optimising speed of transaction for a transaction between a user and a content provider, the method comprising:
for each of one or more possible transaction methods, determining whether a transaction method is permitted between the said user and the said content provider for the said item of content; and
selecting a fastest transaction method from one or more permitted transaction methods.

15. A method of minimising transaction error rate for a transaction between a user and a content provider, the method comprising:
for each of one or more possible transaction methods, determining whether a transaction method is permitted between the said user and the said content provider for the said item of content; and
selecting a transaction method having a lowest transaction error rate from one or more permitted transaction methods.

16. A computer readable medium carrying processor control code for controlling a processor to carry out the method of claim 11.

17. Hardware configured to, when running, carrying out the method of claim 11.

18. An apparatus for enabling a user of a mobile device to select a billing method for a transaction to acquire an item of content, the apparatus comprising a meta-payment server configured to communicate with a plurality of billing servers for a plurality of payment providers, a plurality of content providers and one or more phone networks each having a plurality of said used, the meta-payment sever comprising: —
means for logging content provider data from one or more of said content providers, said content provider data comprising a content provider identification, and content item meta data for a plurality of items of content, said content item meta data comprising a resource location address for a link to be displayed by said content provider on a content provider mobile web site for access by a said user to obtain a said item of content, price data associated with said item of content, and a content item identifier identifying said item of content;
means for logging phone network data from said phone network, said phone network data comprising at least a user identification number of said user;
means for storing in a data store a list of available payment methods, each having payment method data defining allowed types of content for which a payment using the payment method may be made and a maximum transaction value;
means for generating an account or identifying an existing account for said user using said user identification number, said account comprising, in an account data store, a transaction history for said user, wherein said transaction history comprises data defining previous successful and unsuccessful payments made by said user and said payment method for each said payment;
means for receiving a content provider request from a content provider or from a content provider via a user, said content provider request comprising a request for said meta-payment server to serve a list of payment methods to said user in response to said content provider receiving a request from said user to purchase a said item of content by activation of said link, said item of content being identified by a said content item “Bango No.” identifier provided with said content provider request;
means for reading said content item metadata for said identified item of content;
means for reading a recent portion of said transaction history data for said user from said account data store;
means for identifying a selection comprising a plurality of said available payment methods for said user to pay for said item of content by filtering said available payment methods for said user to pay for said item of content by filtering said available payment methods using said portion of said transaction history and said content item meta data for said item of content in association with said payment method data; and
means for sending from said meta-payment server to said user via said phone network of said user, as a mobile web page, said identified selection of a plurality of available payment methods as a set of links each of said links activating a respective said payment method, together with a price of said item of content such that by selecting a said link the user is able to pay by the selected method.

19. An apparatus for determining a preferred transaction method for a transaction between a user and a content provider, the transaction involving an item of content, the apparatus comprising:
a data memory storing one or more possible transaction methods; and
a processor coupled to said data memory and to program memory storing processor control code for controlling the processor, when running, to:
for each of said one or more possible transaction methods, determine whether a transaction method is permissible between the said user and the said content provider for the said item of content; and
select a preferred transaction method from one or more permitted transaction methods according to rules.
